(19) United States
(12) Patent Application Publication
(10) Pub. No.: US 2009/0225414 A1
(43) Pub. Date: Sep. 10, 2009

(54) Dark Field Objective for a Microscope

(76) Inventors: Michael Heiden, Woelfersheim (DE); Wolfgang Vollrath, Burbach (DE)

Correspondence Address: SIMPSON & SIMPSON, PLLC, 5555 MAIN STREET, WILLIAMSVILLE, NY, 14221-5406, US

(21) Appl. No.: 12/083,108

(22) PCT Filed: Sep. 24, 2006
(86) PCT No.: PCT/EP2006/066653

§ 371 Date: Apr. 4, 2008

(30) Foreign Application Priority Data
Oct. 5, 2005 (DE) 10 2005 047 847.6

(51) Int. Cl. G02B 21/10

(52) U.S. Cl. 359/387

(57) ABSTRACT

The invention relates to an objective for a microscope for dark field microscopy having alternating illumination with grazing incidence. A dark field objective is shown having a front lens for receiving light from a sample and having a dark field illumination device for guiding illumination light onto the sample, the dark field illumination device comprising at least one pair of light decoupling elements, which are each situated in pairs around the front lens opposite to the optical axis for counter parallel illumination of the sample.

### CROSS-REFERENCE TO RELATED APPLICATIONS

This application is the National Stage of PCT International Application No. PCT/EP2006/066653, filed Sep. 24, 2006, which application published in German and is hereby incorporated by reference in its entirety; said international application claims priority from German Patent Application No. 10 2005 047 847.6, filed Oct. 5, 2005 which is incorporated by reference in its entirety.

### FIELD OF THE INVENTION

The invention relates to an objective for a microscope for dark field microscopy having alternating illumination with grazing incidence.

### BACKGROUND OF THE INVENTION

An objective for dark field microscopy is known according to German Patent No. DE 199 03 486 C2. In the known objective, an annular beam bundle is led around the objective lens system and deflected concentrically at an angle onto the sample in the area of the sample-side end of the objective lens system.

Illumination for dark field microscopy having alternating illumination with grazing incidence according to the so-called AGID method (alternating grazing incidence) is known according to B. Brodermann et al.: “Alternating grazing incidence dark field scanning optical microscopy for dimensional measurements,” Proc. of SPIE 4277:352-361 (2002). In this method, the sample is illuminated alternately from two opposite directions perpendicular to a sample structure with grazing incidence. The illumination occurs laterally from the objective.

The AGID method presumes a main structure direction on the sample, such as printed conductors of a wafer. The sample is oriented having its main structure direction perpendicular to the illumination directions. The conductors to be examined are illuminated in sequence from one side and from the opposite side perpendicular to the main structure direction, a separate image being recorded for each illumination procedure. Two images of the same recording area result in each case. One illumination direction emphasizes one edge side, and the other illumination direction emphasizes the other edge side. The two images are analyzed individually for the position of the corresponding edges and subsequently the analyzed images are superimposed. It is thus possible to resolve structure widths smaller than half of the light wavelength. The illumination light is preferably polarized in such a way that the electric field is oriented parallel to the edge of the structure.

The known prior art has the disadvantage that it is either unsuitable for the AGID method or requires a complicated construction.

### BRIEF SUMMARY OF THE INVENTION

The invention is therefore based on the object of specifying an illumination device for a microscope for dark field microscopy having alternating illumination with grazing incidence, which is simple and compact.

This object is achieved by the dark field objective specified herebelow. Advantageous embodiments of the invention are specified in the further description herebelow.

According to the invention, the object is achieved in a dark field objective for a microscope having a front lens for receiving light from a sample and having a dark field illumination device for guiding illumination light onto the sample in that the dark field illumination device comprises at least one pair of light decoupling elements, which are each situated opposite to the optical axis around the front lens for alternating, counter parallel illumination of the sample. The junction of objective and counter parallel illumination allows the execution of the illumination to be designed simply and compactly.

The light decoupling elements are expediently offset by 180° in pairs. This implements the effect intended in the AGID method most favorably.

Decoupling elements are preferably prisms. These are simpler to position than mirrors and permit the objective to be designed having its terminating face encapsulated.

The prisms and the front lens favorably end on the probe side in the area of a joint plane. This results in an especially compact construction.

The prisms and the front lens ideally end on the probe side in a joint plane for contact on an immersion liquid film. The AGID method using a simple objective is thus accessible for microscopy using immersion liquid.

According to one embodiment, the dark field illumination device guides the illumination light in at least one beam pair through the objective. The top side of the objective may thus simultaneously be used for the exit of the imaging beam and for the entry of the illumination beams. The construction of the objective thus becomes especially compact, like that of the entire microscope.

According to a preferred embodiment, the dark field illumination device guides the illumination light through the objective at least partially parallel to the optical axis. This implements especially simple beam guiding.

According to a further embodiment, the dark field illumination device receives the illumination light perpendicular to the optical axis from an illumination source. The coupling may thus occur directly from the side into the objective. A coupling mirror above the objective may thus be saved.

The dark field illumination device and the front lens are especially advantageously enclosed by a shared housing. An especially compact and robust construction is thus achieved. The configuration is less susceptible to misalignment.

According to a refinement of the invention, the dark field illumination device comprises two pairs of light decoupling elements, which are situated crossed in pairs. It is possible through this configuration to apply the AGID method to a sample having a crossed structure.

Ideally, the dark field illumination device is provided for decoupling the illumination light onto the sample at an angle of 65° to 89°, in particular 75° to 80° to the optical axis. It has been shown that the specified angle ranges result in especially good imaging.

These and other objects and advantages of the present invention will be readily appreciable from the following description of preferred embodiments of the invention and from the accompanying drawings and claims.

### BRIEF DESCRIPTION OF THE DRAWINGS

In the following, the invention is explained in greater detail on the basis of schematic illustrations of an exemplary embodiment. Identical reference numerals in the individual figures identify identical elements. The figures include:

FIG. 1 shows an objective having decoupling prisms;

FIG. 2 shows an objective having decoupling mirrors;

FIG. 3 shows an immersion objective having decoupling prisms;

FIG. 4 shows an objective according to the invention from the bottom side;

FIG. 5 shows an assigned illumination device; and, FIG. 6 shows a schematic sketch of the assigned microscope.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

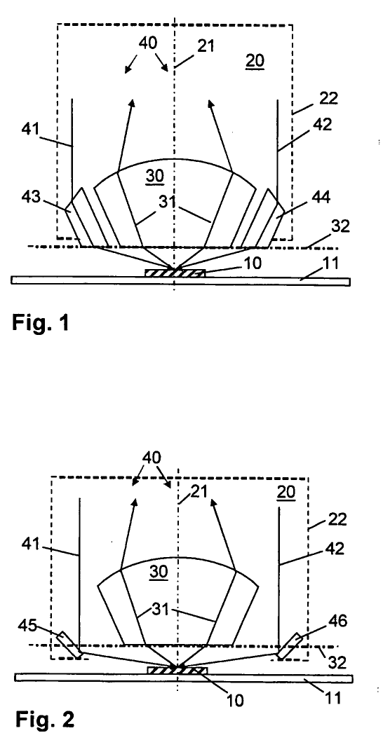

FIG. 1 shows an objective 20 according to the invention over a sample 10 on a sample support 11. The objective comprises a front lens 30 and a left decoupling prism 43 and a right decoupling prism 44. The front lens 30 and the prisms 43 and 44 terminate at a joint plane 32. The front lens and the prisms are partially enclosed by the housing 22 of the objective. The prisms 43 and 44 form a part of the dark field illumination device 40. The alternately incident left and right illumination beams 41 and 42, respectively, are shown simultaneously visible in all figures for simplification. The illumination beams 41 and 42 are respectively incident on the prisms 43 and 44 parallel to the optical axis 21 inside the housing 22. These prisms deflect the illumination beams in a grazing manner onto the sample 10. The imaging beams 31 are received by the front lens 30 from the sample 10.

FIG. 2 shows an objective 20 according to the invention analogous to the objective of FIG. 1. Instead of the prisms, a left and a right decoupling mirror 45 and 46, respectively, are provided here. The decoupling mirrors are located in the area of the plane 32 of the sample-side end of the front lens. They may also be situated slightly above or also beneath.

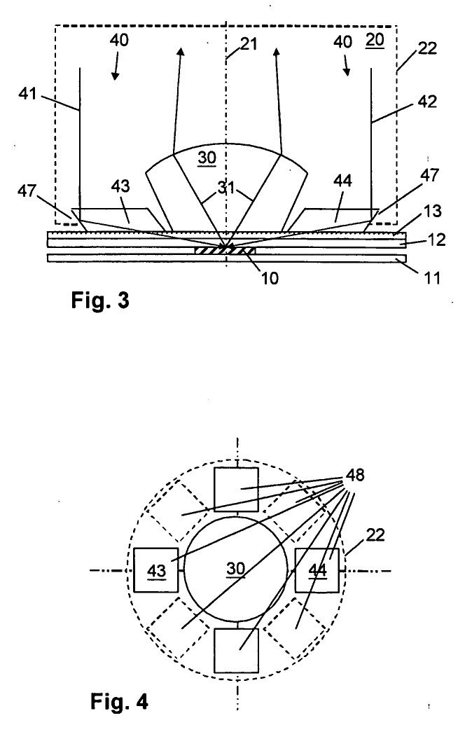

FIG. 3 shows an objective 20 according to the invention for use with immersion media, again analogous to the objective from FIG. 1. The sample is fixed here using a sample cover 12. The immersion liquid 13 is located between the sample cover and the sample-side end of the front lens and the sample-side end of the prisms 43 and 44. This liquid is a liquid having an index of refraction in the range of the front lens 30. The illumination beams 41 and 42 respectively incident on the prisms 43 and 44 parallel to the optical axis are reflected here inside the prisms 43 and 44 in the direction of the sample 10 and exit largely non-refracted from the prisms into the immersion liquid. The prisms are implemented here as parallelograms for this purpose.

FIG. 4 shows the bottom side of a further objective according to the invention analogous to the objective of FIG. 1. The housing 22 comprises 4 pairs of decoupling elements 48 here. The prism pair 43, 44 shown in FIGS. 1 or 3 is shown here. In addition, a prism pair offset crossed to the prism pair 43, 44 is also shown by solid lines. The analysis of two structures of the sample perpendicular to one another is especially well possible through this further prism pair. Furthermore, two further prism pairs offset by 45° in relation to the above-mentioned two prism pairs are shown by dashed lines. The analysis of samples having structures of different directions is thus well possible.

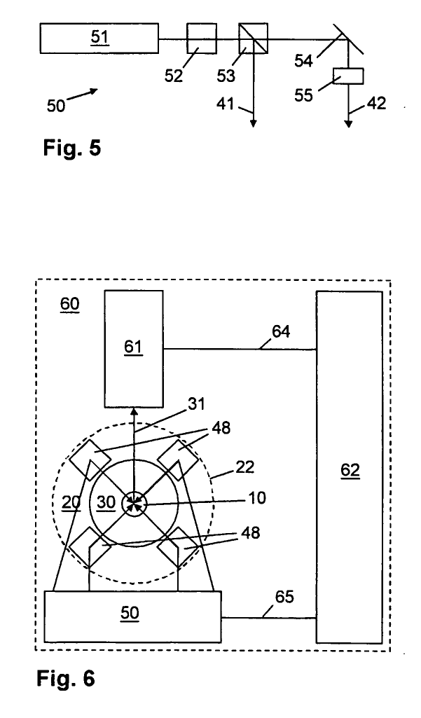

FIG. 5 shows an illumination source 50 of the illumination device 40. The illumination source comprises a laser 51 for linearly polarized light of a wavelength of approximately 500 nm. The laser radiates through a Pockels cell 52 onto a polarization beam splitter 53. This splits the beam into the left illumination beam 41 and, via the mirror 54 and a half-wave plate 55, into the right illumination beam 42. The Pockels cell is driven in such a way that it periodically rotates the polarization and thus forms an optical toggle switch together with the polarization beam splitter 53. The half-wave plate 55 is used for orienting the polarization of the right illumination beam 42. The illumination beams 41 and 42 are ideally oriented in such a way that the electric fields of the illumination beams on the sample 10 are perpendicular to the incidence direction and parallel to the sample structure. The illumination source shown is designed for an objective according to FIGS. 1 through 3. The illumination source is to be expanded analogously for an objective according to FIG. 4.

FIG. 6 shows the principle of a microscope 60 having the objective 20 according to the invention analogous to FIGS. 1 through 4. Two pairs of decoupling elements 48 are implemented here. A control and analysis unit 62 controls, via a connection 65, the illumination source 50 for alternating illumination of the sample 10 via one decoupling element 48 at a time on one hand and the recording of the sample 10 by the camera 61 via a connection 64 on the other hand. The control and analysis unit 62 synchronizes the illumination and the recording and performs the analysis of the individual images and the superposition of analyzed individual images.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

### LIST OF REFERENCE NUMERALS

10 sample
11 sample support
12 sample cover
13 immersion liquid
20 objective
21 optical axis
22 housing
30 front lens
31 imaging beams
32 plane of the sample-side end of the front lens
40 dark field illumination device
41 left illumination beam
42 right illumination beam
43 left decoupling prism
44 right decoupling prism
45 left decoupling mirror
46 right decoupling mirror
47 deflection mirror
48 decoupling elements
50 illumination source
51 laser
52 Pockels cell
53 polarization beam splitter
54 deflection mirror
55 half-wave plate
60 microscope
61 camera
62 control and analysis unit
64 connection to camera
65 connection to illumination source

1-11. (canceled)

12. A dark field objective for a microscope comprising:
a front lens for receiving an imaging light from a sample; and,
a dark field illumination device comprising at least one pair of light decoupling elements arranged around said front lens opposite to an optical axis for alternating, counter parallel illumination of said sample, wherein each light decoupling element of said at least one pair of light decoupling elements is arranged for guiding an illumination light onto a sample.

13. The dark field objective of claim 12, wherein each light decoupling element of said at least one pair of light decoupling elements is offset by one hundred eighty degrees (180°) relative to the other light decoupling element of said at least one pair of light decoupling elements.

14. The dark field objective of claim 12, wherein each light decoupling element of said at least one pair of light decoupling elements is a prism.

15. The dark field objective of claim 14, wherein each of said prisms and said front lens has a surface arranged proximate said sample and said surfaces are arranged coplanar on a joint plane.

16. The dark field objective of claim 14, wherein each of said prisms and said front lens has a surface arranged proximate said sample, said surfaces are arranged coplanar on a joint plane, and said joint plane is arranged for contact with an immersion liquid film.

17. The dark field objective of claim 12, wherein said dark field illumination device guides said illumination light through said objective in at least one illumination beam pair.

18. The dark field objective of claim 12, wherein said dark field illumination device guides said illumination light through said objective at least partially parallel to said optical axis.

19. The dark field objective of claim 12, wherein said dark field illumination device receives said illumination light from an illumination source perpendicular to said optical axis.

20. The dark field objective of claim 12, wherein said dark field illumination device and said front lens are enclosed by a shared housing.

21. The dark field objective of claim 12, wherein said dark field illumination device comprises two pairs of light decoupling elements, and said two pairs of light decoupling elements are offset by an angle greater than zero degrees (0°) and less than one hundred eighty degrees (180°) relative to each other.

22. The dark field objective of claim 12, wherein said dark field illumination device is arranged to decouple said illumination light onto said sample at an angle greater than or equal to sixty five degrees (65°) and less than or equal to eighty nine degrees (89°) relative to said optical axis.

23. The dark field objective of claim 22, wherein said angle is greater than or equal to seventy five degrees (75°) and less than or equal to eighty degrees (80°) relative to said optical axis.
